(19) United States
(12) Patent Application Publication
(10) Pub. No.: US 2023/0063863 A1
(43) Pub. Date: Mar. 2, 2023

(54) ITEM MANAGEMENT APPARATUS, ITEM MANAGEMENT METHOD, AND RECORDING MEDIUM

(71) Applicant: NEC Corporation, Minato-ku, Tokyo (JP)

(72) Inventors: Azusa FURUKAWA, Tokyo (JP); Kan ARAI, Tokyo (JP); Kei SHIBUYA, Tokyo (JP); Hiroshi HASHIMOTO, Tokyo (JP); Ken HANAZAWA, Tokyo (JP); Makiko AKIGUCHI, Tokyo (JP)

(73) Assignee: NEC Corporation, Minato-ku, Tokyo (JP)

(21) Appl. No.: 17/802,642

(22) PCT Filed: Mar. 17, 2020
(86) PCT No.: PCT/JP2020/011631

§ 371 Date: Aug. 26, 2022

(51) Int. Cl. G06Q 10/08; G06T 7/70; G06V 20/40; G06V 40/16

(52) U.S. Cl. CPC G06Q 10/087; G06T 7/70; G06V 20/44; G06V 40/172; G06T 2207/30201; G06T 2207/30242

(57) ABSTRACT

An item management apparatus manages the number of items displayed on an item shelf. An acquisition unit acquires an ideal quantity indicating an ideal number of items to be displayed, and a current quantity indicating the number of items being actually displayed on the item shelf. A detection unit detects the number of times of taking out and placing back an item with respect to the item shelf. An ideal quantity correction unit corrects the ideal quantity based on the current quantity and the number of times of taking out and placing back the item.

### TECHNICAL FIELD

The present disclosure relates to a technique for managing items to be displayed on shelves at a store.

### BACKGROUND ART

A method for managing an allocation of items to shelves using captured images of the shelves in stores has been proposed. For example, Patent Document 1 discloses an item shelf allocation management apparatus for determining whether to execute an item allocation inspection based on whether a type and an arrangement state of the items appearing in the captured images of the shelves match with a predetermined type and a predetermined arrangement state of the items.

### PRECEDING TECHNICAL REFERENCES

### Patent Document

Patent Document 1: International Publication Pamphlet No. WO2016/117600

### SUMMARY

### Problem to be Solved by the Invention

In general, the number of items to be displayed on each shelf is predetermined, and in a case where there is a shortage of items displayed on the shelf, a deliverer replenishes the items. The number of items to be displayed on the shelf is preferably an ideal number that meets actual needs of customers. In a case where the number of items displayed on the shelves is greater than the actual needs, it will lead to losses such as disposals of the items, and in a case where the number of items is fewer, it will lead to occur a loss of an opportunity to sell the items.

It is one object of the present disclosure to provide an item management apparatus capable of displaying an appropriate number of the items on shelves that meets the actual needs of the customers.

### Means for Solving the Problem

According to an example aspect of the present disclosure, there is provided an item management apparatus including:

an acquisition unit configured to acquire an ideal quantity indicating an ideal number of items to be displayed, and a current quantity indicating a number of items being actually displayed on an item shelf;

a detection unit configured to detect a number of times of taking out and placing back an item with respect to the item shelf; and

an ideal quantity correction unit configured to correct the ideal quantity based on the current quantity and the number of times of taking out and placing back the item.

According to another example aspect of the present disclosure, there is provided an item management method including:

acquiring an ideal quantity indicating an ideal number of items to be displayed, and a current quantity indicating a number of items being actually displayed on an item shelf;

detecting a number of times of taking out and placing back an item with respect to the item shelf; and

correcting the ideal quantity based on the current quantity and the number of times of taking out and placing back the item.

According to a further example aspect of the present disclosure, there is provided a recording medium storing a program, the program causing a computer to perform a process including:

acquiring an ideal quantity indicating an ideal number of items to be displayed, and a current quantity indicating a number of items being actually displayed on an item shelf;

detecting a number of times of taking out and placing back an item with respect to the item shelf; and

correcting the ideal quantity based on the current quantity and the number of times of taking out and placing back the item.

### Effect of the Invention

According to the present disclosure, it becomes possible to provide an item management apparatus capable of displaying an appropriate number of items on shelves that meets actual needs of customers.

### BRIEF DESCRIPTION OF THE DRAWINGS

FIG. 1 illustrates a schematical configuration of an item management apparatus according to a first example embodiment.

FIG. 2 is a block diagram illustrating a hardware configuration of a server.

FIG. 3 is a block diagram illustrating a functional configuration of the server according to the first example embodiment.

FIG. 4 is a flowchart of a support information display process.

FIG. 5 illustrates examples of a current quantity, an ideal quantity, and the number of times of taking-out and placing-back.

FIG. 6 is a flowchart of a first example of an ideal state correction process.

FIG. 7 illustrates an example of the number of times of the taking-out and placing-back which are stored for each customer.

FIG. 8 is a flowchart of a second example of the ideal state correction process.

FIG. 9 illustrates a schematical configuration of an item management apparatus according to a second example embodiment.

FIG. 10 is a block diagram illustrating a functional configuration of a server according to the second example embodiment.

FIG. 11 is a block diagram illustrating a functional configuration of an item management apparatus according to a third example embodiment.

### EXAMPLE EMBODIMENTS

In the following, example embodiments will be described with reference to the accompanying drawings.

### First Example Embodiment

[Overall Configuration]

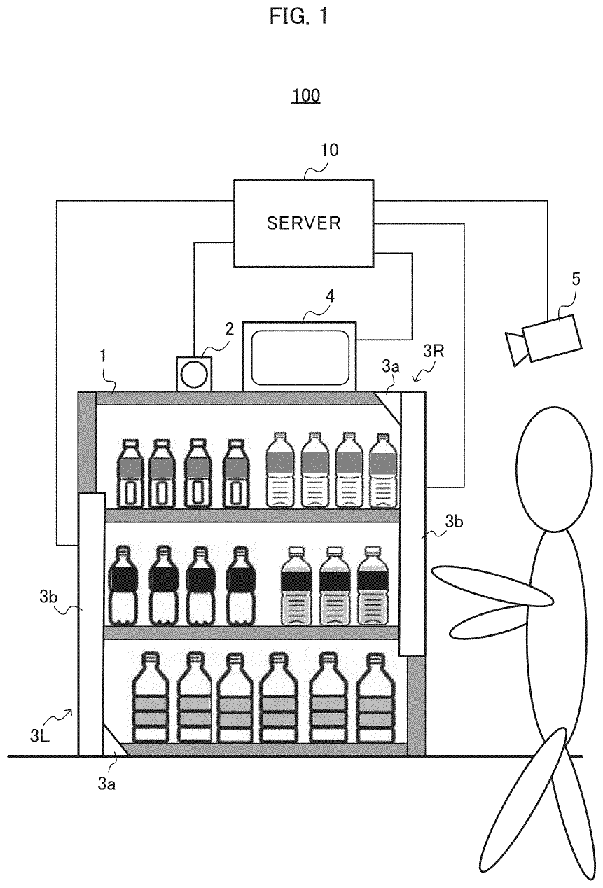

FIG. 1 illustrates a schematic configuration of an item management apparatus according to a first example embodiment. The item management apparatus 100 manages items to be displayed on an item shelf 1 in a store. The item management apparatus 100 includes a camera 2 for a person, cameras 3R and 3L for the items, a display device 4, a camera 5 for a shelf, and a server 10. The camera 2 for the person, the cameras 3R and 3L for the items, the display device 4, and the camera 5 for the shelf communicate with the server 10 by a wired or wireless means.

The camera 2 for the person is installed on an upper portion of the item shelf 1. The camera 2 for the person takes a picture of a customer who is in front of the item shelf 1, and captures a portion including at least a face of the customer. The camera 2 for the person sends an image of the customer to the server 10. In the following description, a video or a still image may be indicated in a case where the “image” is referred to, and the video is indicated in a case where streaming is referred to.

The cameras 3R and 3L for the items are provided to detect loading and unloading of the items with respect to the item shelf 1, and output the video obtained by capturing a state in which the customer takes out the item from the shelf and a state in which the item is placed back to the shelf, to the server 10. In this example embodiment, a pair of the cameras 3R and 3L for the items is attached to a frame of the item shelf 1. Each of the cameras 3R and 3L for the items includes a camera unit 3a and an illumination unit 3b. In the camera 3R for the items attached to the right side of the item shelf 1, while the illumination unit 3b is illuminating the front and the front region of the item shelf 1, the camera unit 3a provided in the upper right corner of the item shelf 1 captures the entire front and the front region of the item shelf 1 in the lower left direction. Similarly, even in the camera 3L for the items attached to the left side of the item shelf 1, while the illumination unit 3b is illuminating the front and the front region of the item shelf 1, the camera unit 3a provided in the lower left corner of the item shelf 1 captures the front and the whole front region of the item shelf 1, in the upper right direction. Since the cameras 3R and 3L at the left side and the right side are used to capture hands of the customer who picks up and places back the item, from the left side and the right side, even in a case where the item is hidden by one hand of the customer in one of the left image and the right image, the item in the hand of the customer can be captured in another image.

The display device 4 is, for instance, a liquid crystal display or the like, and displays support information related to deliveries of the items to a person (hereinafter, referred to as a “deliverer”) who displays the items on the item shelf 1. The information displayed on the display device 4 is transmitted from the server 10.

The camera 5 for the shelf captures an image of the items displayed on the item shelf 1. In the present example embodiment, the camera 5 for the shelf captures the entire front of the item shelf 1 and transmits each captured image to the server 10. The camera 5 for the shelf is used to determine a display state of each of the items on the item shelf 1, specifically whether each of the items is placed in a correct orientation.

[Server Hardware Configuration]

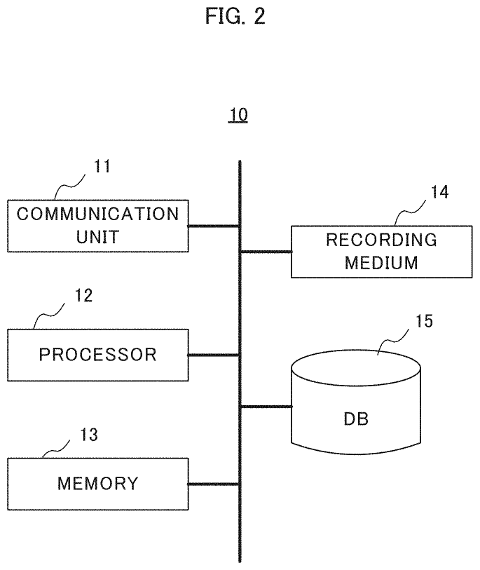

FIG. 2 is a block diagram illustrating a hardware configuration of the server 10. As illustrated, the server 10 includes a communication unit 11, a processor 12, a memory 13, a recording medium 14, and a database (DB) 15.

The communication unit 11 communicates with the camera 2 for the person, the cameras 3R and 3L for the items, the display device 4, and the camera 5 for the shelf by the wired or wireless means. The processor 12 is a computer such as a CPU (Central Processing Unit) and controls the entire server 10 by executing programs prepared in advance. Specifically, the processor 12 executes a support information display process and an ideal state correction process, which will be described later.

The memory 13 is formed by a ROM (Read Only Memory), a RAM (Random Access Memory), or the like. The memory 13 is also used as a working memory during executions of various processes by the processor 12.

The recording medium 14 is a non-volatile and non-transitory recording medium such as a disk-shaped recording medium, a semiconductor memory, or the like, and is formed to be detachable from the server 10. The recording medium 14 records various programs executed by the processor 12. When the server 10 executes various kinds of processes, programs recorded on the recording medium 14 are loaded into the memory 13, and executed by the processor 12.

The database 15 stores videos transmitted from the camera 2 for the person, the cameras 3R and 3L for the items, the camera 5 for the shelf, and the like. Furthermore, the database 15 stores information related to the items to be displayed on the item shelf 1 and facial images of deliverers. Note that the server 10 may include a keyboard for a clerk to perform an instruction and inputs, an input section such as a mouse, and a display section such as a liquid crystal display.

[Functional Configuration of Server]

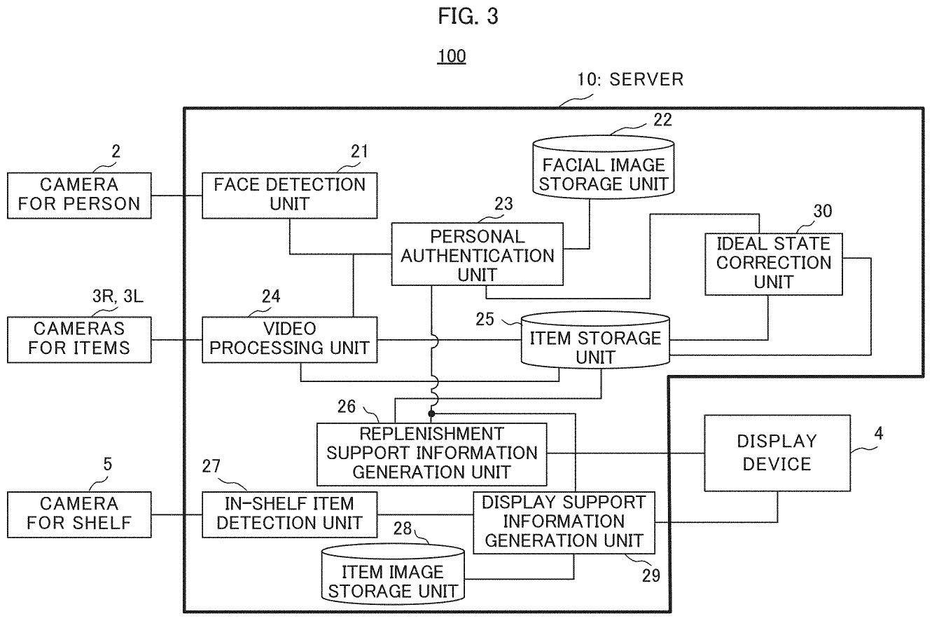

FIG. 3 is a block diagram illustrating a functional configuration of the server 10. The server 10 functionally includes a face detection unit 21, a facial image storage unit 22, a personal authentication unit 23, a video processing unit 24, an item storage unit 25, a replenishment support information generation unit 26, an in-shelf item detection unit 27, an item image storage unit 28, a display support information generation unit 29, and an ideal state correction unit 30.

The face detection unit 21 acquires an image including the face of the person in front of the item shelf 1 from the camera 2 for the person, detects a portion of the face in the image, and outputs a facial image to the personal authentication unit 23. The facial image storage unit 22 stores the facial images of the deliverers prepared in advance. The personal authentication unit 23 matches the facial image of the person in front of the item shelf 1 with each of the facial images of the deliverers stored in the facial image storage unit 22, and determines whether or not the person in front of the item shelf 1 is the deliverer. After that, the personal authentication unit 23 outputs information indicating whether or not the person in front of the item shelf is the deliverer to the video processing unit 24, the replenishment support information generation unit 26, the display support information generation unit 29, and the ideal state correction unit 30.

The item storage unit 25 stores product images for items to be displayed on the item shelf 1. In addition, the item storage unit 25 stores the number of items (hereinafter referred to as a “current quantity”) per product currently placed on the item shelf 1, an ideal number of items (hereinafter referred to as an “ideal quantity”) per product to be placed on the item shelf 1, and a number of times (hereinafter referred to as a “number of times of taking-out and placing-back”) per product in a case where an item is taken out and placed back with respect to the item shelf 1. Note that the ideal quantity is a predetermined quantity per product. Moreover, the current quantity is calculated and updated based on the quantity per product displayed on the item shelf 1 at an initial time or at every delivery, that is, based on the ideal quantity and the number of times of taking-out and placing-back subsequently with respect to the item shelf 1.

The video processing unit 24 acquires a video in which the item is taken out and placed back with respect to the item shelf 1 (hereinafter, also referred to as a “video of taking-out and placing-back”), from the cameras 3R and 3L for the items. The video processing unit 24 compares the video of the taking-out and placing-back acquired from the cameras 3R and 3L for the items, with each of the images of products stored in the item storage unit 25 in order to determine an increase or a decrease in the current quantity due to the taking-out and placing-back of items per product. When the delivery of the items by the deliverer is completed, the items are displayed with the ideal quantity on the item shelf 1. When determining that one item is taken out from the item shelf 1 based on the video of the taking-out and placing-back, the video processing unit 24 decreases the current quantity for that product stored in the item storage unit 25 by one. On the other hand, when determining that one product is replenished based on the video of the taking-out and placing-back, the video processing unit 24 increases the current quantity of the items for that product stored in the item storage unit 25 by one. Accordingly, the video processing unit 24 updates the current quantity of the items per product stored in the item storage unit 25 each time the item concerning the product is taken out from and placed back to the item shelf 1 based on the video of the taking-out and placing-back. Therefore, the current quantity of the items per product at that time is always stored in the item storage unit 25.

When receiving information indicating that a person in front of the item shelf is the deliverer from the personal authentication unit 23, the replenishment support information generation unit 26 generates replenishment support information based on the current quantity and the ideal quantity of the items per product at that time. Specifically, the replenishment support information generation unit 26 calculates a quantity to be replenished by the following equation.

(quantity to be replenished)=(ideal quantity)−(current quantity)

Accordingly, the replenishment support information generation unit 26 generates replenishment support information including each name of products that need to be replenished and the quantity to be replenished, and displays the generated replenishment support information on the display device 4. By these processes, for instance, the replenishment support information such as “Replenish two items for the product A and reduce one item for the product B.” is displayed on the display device 4.

The in-shelf item detection unit 27 acquires a captured image of the entire item shelf 1 from the camera 5 for the shelf, and extracts an image of each item from the captured image. Then, the in-shelf item detection unit 27 outputs the detected image of each item to the display support information generation unit 29. The item image storage unit 28 stores an image in a case where each item is placed in the correct orientation, that is, a front image of each product. When receiving information indicating that the person in front of the item shelf is the deliverer from the personal authentication unit 23, the display support information generation unit 29 matches the image of each item input from the in-shelf item detection unit 27 with the front image of each product stored in the item image storage unit 28, and generates display support information indicating each item that is not placed in the correct orientation. Next, the display support information generation unit 29 displays the generated display support information on the display device 4. Accordingly, for instance, the display support information such as a message of “Please place the product C and the product H in the correct orientation.” is displayed on the display device 4.

The ideal state correction unit 30 corrects the ideal quantity per product based on the current quantity, the ideal quantity, and the number of times of taking-out and placing-back per product stored in the item storage unit 25. Note that a correction of the ideal state will be described in detail later.

In the above configuration, the ideal state correction unit 30 corresponds to examples of an acquisition unit, an ideal quantity correction unit, a sales quantity calculation unit, an interest level determination unit, and a correction process unit, the video processing unit 24 corresponds to an example of a detection unit, the personal authentication unit 23 corresponds to examples of a deliverer determination unit, and the replenishment support information generation unit 26 and the display support information generation unit 29 correspond to an example of a display control unit.

[Support Information Display Process]

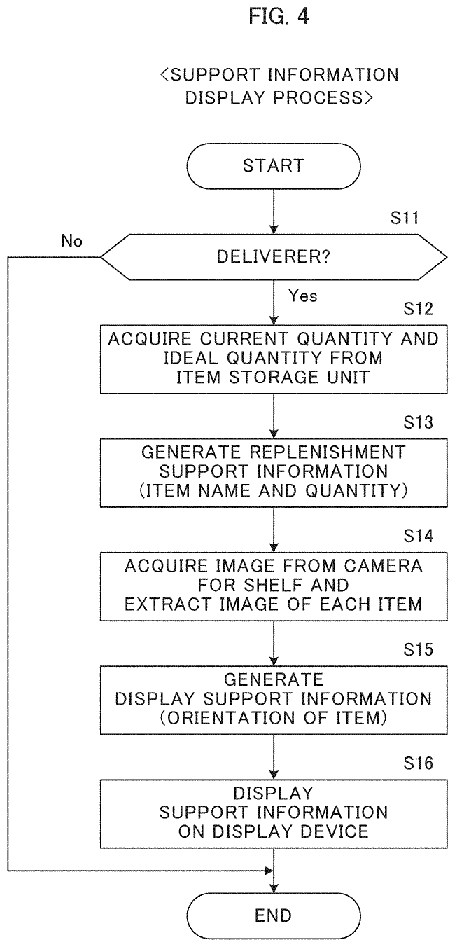

Next, the support information display process performed by the server 10 will be described. FIG. 4 is a flowchart of the support information display process. This process is realized by the processor 12 illustrated in FIG. 2, which executes programs prepared in advance and operates as each element depicted in FIG. 3. First, the personal authentication unit 23 of the server 10 determines whether or not a person in front of the item shelf 1 is the deliverer based on the facial image of the person acquired from the camera 2 for the person (step S11). When the person is not the deliverer (step S11: No), the support information display process is terminated. On the other hand, when the person is the deliverer (step S11: Yes), the replenishment support information generation unit 26 acquires the current quantity and the ideal quantity per product at that time from the item storage unit 25 (step S12), and generates replenishment support information including each name of products that need to be replenished and the quantity to be replenished (step S13).

Next, the in-shelf item detection unit 27 acquires an image of the entire item shelf 1 at that time from the camera 5 for the shelf, and extracts an image of each item (step S14). Next, the display support information generation unit 29 determines an orientation of each of the items based on the image for each of the items, and generates display support information indicating each item that is not placed in the correct orientation (step S15). Next, the replenishment support information generation unit 26 outputs and displays the replenishment support information on the display device 4, and the display support information generation unit 29 also outputs and displays the display support information to the display device 4 (step S16). After that, the support information display process is terminated.

As described above, according to the support information display process, at a timing when the deliverer comes in front of the item shelf 1, the replenishment support information and the display support information are displayed on the display device 4. Therefore, it is possible for the deliverer to efficiently replenish and display items by looking at the displayed support information.

[Correction of Ideal State]

Next, a correction of the ideal state by the ideal state correction unit 30 will be described. As described above, the deliverer replenishes items so that the current quantity of items per product actually placed on the item shelf 1 matches the ideal quantity of items per product stored in the item storage unit 25. Here, in a case where the ideal quantity is greater than actual needs of customers, items are unsold and it will lead to losses such as disposals. On the other hand, in a case where the ideal quantity is less than the actual needs of customers, an opportunity to sell more items is lost. Therefore, it is preferable that the ideal quantity of items per product be a quantity that matches the actual needs of customers. Accordingly, in the present example embodiment, the ideal state correction unit 30 corrects the ideal quantity of items per product by estimating the actual needs of customers. Specifically, the ideal state correction unit 30 corrects the ideal quantity using the current quantity, the ideal quantity, and the number of times of the taking-out and placing-back, which are stored in the item storage unit 25. Hereinafter, as a method for correcting the ideal state, two examples will be described.

### First Example

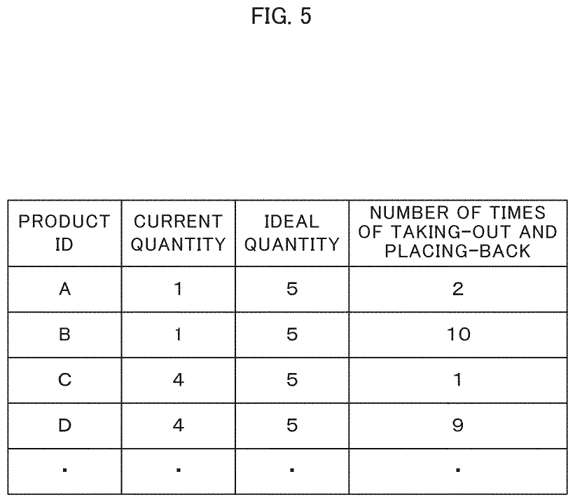

First, a first example of a method for correcting an ideal state will be described. FIG. 5 illustrates an example of the current quantity, the ideal quantity, and the number of times of the taking-out and placing-back during a period from a time of a previous delivery to a time of a current delivery (hereinafter referred to as the “delivery cycle”) by the deliverer. The ideal state correction unit 30 first calculates the quantity per product sold (sales quantity) in one delivery cycle by using the current quantity and the ideal quantity in accordance with the following equation.

(sales quantity)=(ideal quantity)−(current quantity)

Moreover, the ideal state correction unit 30 determines the interest level of customers for each product based on the number of times of the taking-out and placing-back. The number of times of taking out an item from and placing back the item to the item shelf 1 is counted by one when the item is taken out from the item shelf 1 and is also counted by one when the item is placed back to the item shelf 1. In a case where a customer takes out and observes an item, and returns the item to the item shelf 1 without purchasing the item, the number of times of the taking-out and placing-back is counted by two. The number of times of the taking-out and placing-back for each product is related to the interest level of the customer in that product, and it is possible to infer that a product with a large number of times of the taking-out and placing-back is of a high interest level of the customer. Therefore, in a case where the number of times of the taking-out and placing-back is greater than a predetermined number of times with respect to a certain product, the ideal state correction unit 30 presumes that the product is a product having a high interest level of the customers.

After that, the ideal state correction unit 30 corrects the ideal quantity per product as necessary based on the sales quantity of items and the interest level per product. As a basic idea, the ideal quantity is reduced in a case where the product is not sold, and the ideal quantity is retained in a case where the product is sold. However, even in a case where the product is not on sale, when the interest level in that product is high, the ideal quantity is retained, instead of reducing. In addition, in a case where the product is on sale and a high interest level is presented to that product, the ideal quantity is increased. As a result, it is possible to reduce remaining sales and prevent a loss of a sales opportunity.

Specifically, the ideal state correction unit 30 retains or increases the ideal quantity in a case where the sales quantity is equal to or greater than a predetermined reference sales quantity per product, and retains or decreases the ideal quantity in a case where the sales quantity is less than the reference sales quantity. Moreover, the ideal state correction unit 30 determines that the interest level is high in a case where the number of times of the taking-out and placing-back is equal to or greater than a reference number of times per product, and determines that the interest level is low in a case where the number of times of the taking-out and placing-back is less than the reference number of times.

Now, in an example in FIG. 5, the reference sales quantity is set to “two items” and the reference number of times is set to “five times”. In this case, as for the product A, the product is being sold because the sales quantity per product indicates four and is more than the reference sales quantity, but the interest level for that product is low because the number of times of the taking-out and placing-back indicates two times and is less than the reference number of times. Accordingly, the ideal state correction unit 30 retains an ideal quantity ‘five’. As for product B, the product is being sold because the sales quantity indicates four and is more than the reference sales quantity, and the interest level for the product is also high because the number of times of the taking-out and placing-back indicates ten times and is more than the reference number of times. Accordingly, for instance, the ideal state correction unit 30 increases the ideal quantity from five items to six items.

As for a product C, that product is not sold very well because the sale quantity indicates one item and is less than the reference sales quantity, and the interest level for that product is also low because the number of times of the taking-out and placing-back indicates one time and is less than the reference number of times. Accordingly, for instance, the ideal state correction unit 30 decreases the ideal quantity from five items to four items. As for a product D, the product is not sold very well because the sales quantity indicates one item and is less than the reference sales quantity, but the interest level for the product is high because the number of times of the taking-out and placing-back indicates ten times and is more than the reference number of times. Therefore, the ideal state correction unit 30 retains an ideal quantity ‘five’.

In the above example, in a case where the products are being sold, and respective interest levels for the products are high, the ideal quantity is increased; however, instead, an upper limit may be set in a case of increasing the ideal quantity in accordance with an accommodation capacity of the item shelf 1 or the like, and the ideal quantity may not be increased.

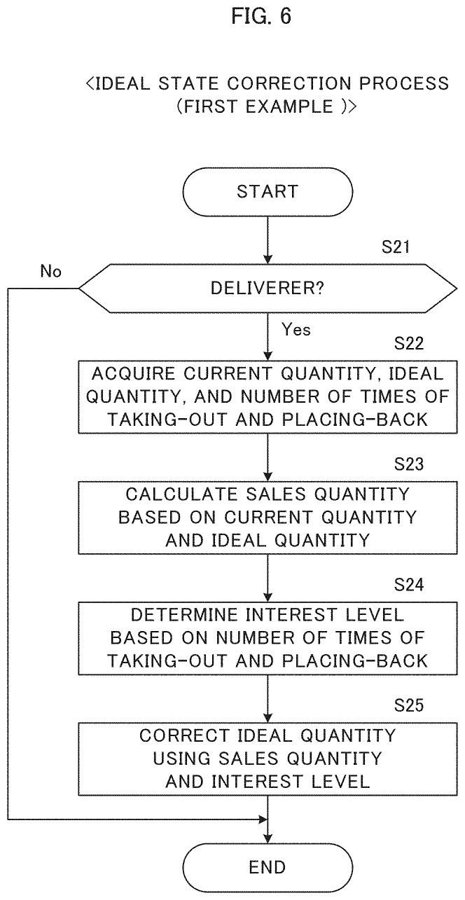

FIG. 6 is a flowchart of a first example of the ideal state correction process. This process is accomplished by the processor 12 illustrated in FIG. 2, which executes a program prepared in advance and operates as each element depicted in FIG. 3.

First, the personal authentication unit 23 of the server 10 determines whether or not a person in front of the item shelf 1 is a deliverer based on a facial image of the person acquired from the camera 2 for the person (step S21). In a case where the person is not the deliverer (step S21: No), the ideal state correction process is terminated. On the other hand, in a case where the person is the deliverer (step S21: Yes), the ideal state correction unit 30 acquires the current quantity, the ideal quantity, and the number of times of the taking-out and placing-back from the item storage unit 25 (step S22).

Next, the ideal state correction unit 30 calculates the sales quantity based on the current quantity and the ideal quantity (step S23), and determines the interest level from the number of times of the taking-out and placing-back (step S24). Subsequently, the ideal state correction unit 30 corrects the ideal quantity stored in the item storage unit 25 using the sales quantity and the interest level by the above-described method (step S25). After that, the ideal state correction process is terminated.

Next, a modification of the first example will be described. In the above-described first example, the ideal state correction unit 30 corrects the ideal quantity using the sales quantity and the number of times of the taking-out and placing-back, but the current quantity may be used instead of the sales quantity. That is, the ideal quantity may be corrected using the current quantity and the number of times of the taking-out and placing-back. In this case, a basic concept is the same as that of the first example; however, it is determined whether or not each product is being sold based on the current quantity per product. In detail, it is determined that a product is being sold when the current quantity is less than a reference current quantity, and that product is not sold when the current quantity is more than the reference current quantity. Since the ideal quantity is usually different for each product, the reference current quantity may be set for each product.

Now, it is assumed that the reference current quantity of a certain product is set to “two items” and the reference number of times of the taking-out and placing-back is set to “five times”. In this case, the ideal state correction unit 30 retains the current quantity in a case where the current quantity is less than two items and the number of times of the taking-out and placing-back is less than five times, and increases the current quantity by one in a case where the current quantity is less than two and the number of times of the taking-out and placing-back is equal to or more than five times. Moreover, the ideal state correction unit 30 retains the current quantity in a case where the current quantity is equal to or more than two items, and decreases the ideal quantity by one in a case where the current quantity is equal to or more than two items and the number of times of the taking-out and placing-back is less than five times. Note that in a case where the current quantity indicates zero, the ideal quantity may be increased by one, regardless of the number of times of the taking-out and placing-back.

### Second Example

Next, a second example of the correction method of the ideal state will be described. In the second example, the method for determining the interest level with respect to each product is different from that of the first example. In the first example described above, the interest level for each product is determined by using the number of times of the taking-out and placing-back by all of a plurality of customers in a single delivery cycle. In contrast, in the second example, the ideal state correction unit 30 stores the number of times of the taking-out and placing-back for each customer, determines the interest level for each customer, and thus determines the interest level of the entire customers.

Specifically, the personal authentication unit 23 identifies a plurality of persons coming in front of the item shelf 1 using the captured images of the camera 2 for the person, applies a person ID or the like to the captured images, and outputs the captured images to the video processing unit 24. In this case, the personal authentication unit 23 does not need to specify whom each person is, and it is sufficient to distinguish whether each person is the same person or a different person. The video processing unit 24 detects the number of times of the taking-out and placing-back, and stores the detected number of times in the item storage unit 25 in association with the person ID. By these processes, the number of times of the taking-out and placing-back of each product can be stored for each person in the item storage unit 25. Note that a method for calculating the sales quality from the current quality and the ideal quality and a method for correcting the ideal quality using the sales quality and the interest level are the same as those in the first example.

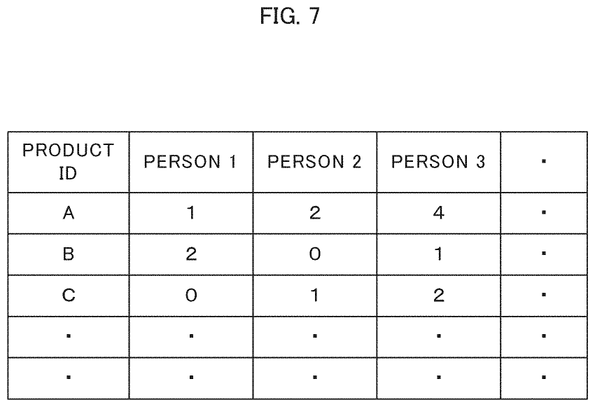

FIG. 7 illustrates an example of the number of times of the taking-out and placing-back stored for each person. When the deliverer appears, the ideal state correction unit 30 acquires the number of times of the taking-out and placing-back for each person as illustrated in FIG. 7 from the item storage unit 25, and determines the interest level for each product in comparison with the reference number of times. In a case where a person takes out an item from the item shelf 1 and observes the item, and places back the item to the item shelf 1, the number of times of the taking-out and placing-back is two times. For instance, in a case where the reference number of times is four times, the ideal state correction unit 30 determines a product, in which the number of times of the taking-out and placing-back is four times or more, as a product in which the person is of interest. In an example illustrated in FIG. 7, it can be determined that a person 3 is interested in the product A and not in other products.

As described above, the ideal state correction unit 30 aggregates the number of persons who are interested in a product for each product, and determines a product, in which the number of persons having interest is equal to or more than a predetermined number, as a product having a high interest level for the entire customers. Alternatively, the ideal state correction unit 30 may determine a product in which a predetermined percentage (for instance, 60%) or more of persons are interested among all persons for each of whom the number of times of the taking-out and placing-back is aggregated, as a product of great interest by the whole of the customers. In the first example, even in a case where the number of times of the taking-out and placing-back is increased as a result from repeating the taking-out and placing-back of the same product by a single person, it is determined that the interest level of the whole of the customers is high due to an influence thereof. In contrast, in the second example, it is possible to separately determine the interest level of an individual person, and to comprehensively determine an overall interest level.

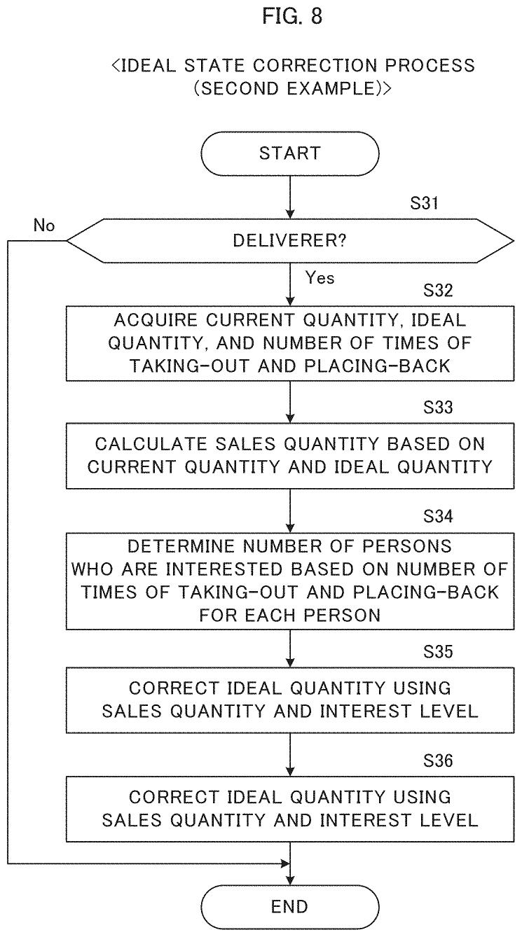

FIG. 8 is a flowchart of the ideal state correction process according to the second example. This process is accomplished by the processor 12 illustrated in FIG. 2, which executes a program prepared in advance and operates as each element depicted in FIG. 3.

First, the personal authentication unit 23 of the server 10 determines whether or not a person in front of the item shelf 1 is a deliverer based on a facial image of the person acquired from the camera 2 for the person (step S31). When the person is not the deliverer (step S31: No), the ideal state correction process is terminated. On the other hand, when the person is the deliverer (step S31: Yes), the ideal state correction unit 30 acquires the current quantity, the ideal quantity, and the number of times of the taking-out and placing-back from the item storage unit 25 (step S32).

Next, the ideal state correction unit 30 calculates the sales quantity based on the current quantity and the ideal quantity (step S33). Moreover, the ideal state correction unit 30 determines, for each product, a person having a number of times of the taking-out and placing-back which is equal to or more than the predetermined number of times, based on the number of times of the taking-out and placing-back for each person illustrated in FIG. 7, as a person who is interested in the product (step S34). Furthermore, the ideal state correction unit 30 aggregates the number of persons who are interested in a product for each product, and determines the product as a product having a high interest level for the whole of the customers in a case where the number of persons who are interested in the product is equal to or greater than a predetermined number, (step S35). Subsequently, the ideal state correction unit 30 corrects the ideal quantity stored in the item storage unit 25 by using the sales quantity and the interest level (step S36). The method for correcting the ideal quantity using the sales quantity and the interest level is the same as in that in the first example. After that, the ideal state correction process is terminated.

Also in the second example, it may be determined whether or not the product is being sold using the current quantity, instead of the sales quantity. That is, the ideal state correction unit 30 may correct the ideal quantity using the current quantity and the interest level.

[Modifications]

Next, modifications of the present example embodiment will be described. The following modifications can be applied in combination as appropriate.

(Modification 1)

The server 10 may display a correction description of the ideal quantity by the ideal state correction process on the display device 4 and may report to the deliverer. By this process, it is possible for the deliverer to adjust the quantity of items to be prepared for each product at the next delivery and at subsequent deliveries.

(Modification 2)

In the above example embodiment, in a case where the current quantity is deviated from the ideal quantity per product, the replenishment support information is displayed on the display device 4; however, in a case where the deliverer mistakenly replenishes too many items, the server 10 may immediately feed back to the deliverer by a method for controlling the display device 4 to emit a warning sound and to perform a warning display. In addition, even in a case where the replenishment by the deliverer is insufficient and the deliverer attempts to leave that place while the current quantity is deviated from the ideal quantity, the server 10 may provide feedback by the warning sound, the warning display, or the like.

A touch panel display may be used as the display 4 to allow the deliverer to input a change in the ideal quantity or to set the ideal quantity for a new product. In the above embodiment, the display device 4 is attached to the item shelf 1; however, instead, a tablet terminal or the like used by the deliverer may be used as the display device.

(Modification 3)

In the above-described embodiment, the personal authentication unit 23 determines whether or not a person in front of the item shelf is the deliverer, by using a facial image taken by the camera 2 for the person. Alternatively, the personal authentication unit 23 may perform an authentication of the deliverer based on a uniform or a badge of the person captured by the camera 2 for the person or the like.

(Modification 4)

In the above embodiment, as support information, both the replenishment support information for replenishing the item and the display support information for placing the item in the correct orientation are generated and displayed; however, the replenishment support information alone may be generated and displayed.

### Second Example Embodiment

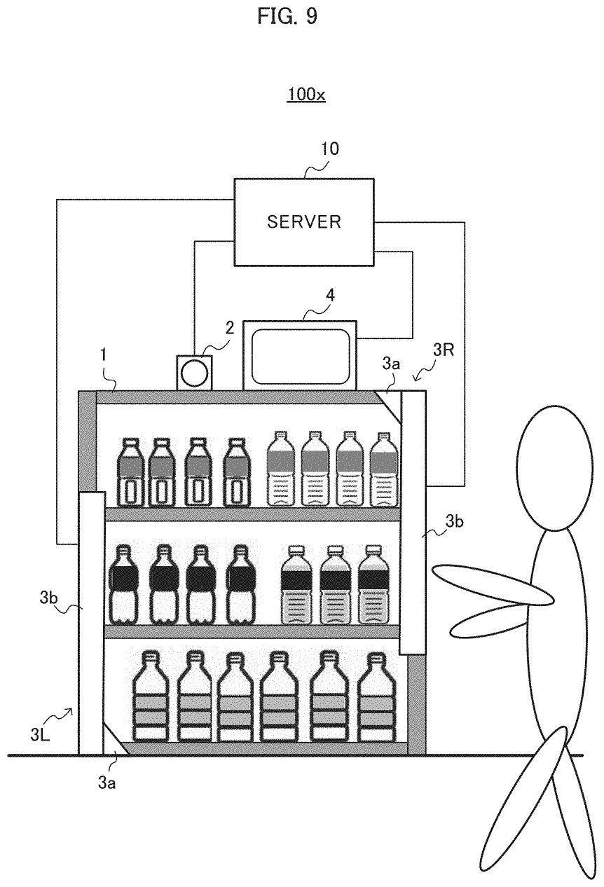

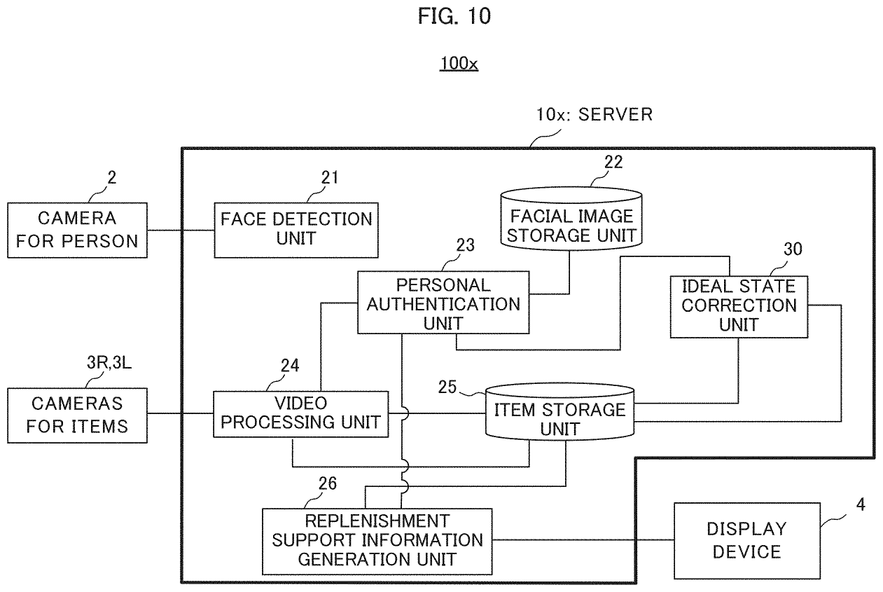

Next, a second example embodiment of the present disclosure will be described. In the second example embodiment, the camera for the shelf is not provided, and the display of display support information is not performed. Except from this point, the second example embodiment is the same as the first example embodiment. FIG. 9 illustrates a schematic configuration of an item management apparatus 100x according to the second example embodiment. As can be understood from the comparison with FIG. 1, although the item management apparatus 100x does not include the camera 5 for the shelf, other configurations are the same as those in the item management apparatus 100 according to the first example embodiment. FIG. 10 illustrates a functional configuration of a server 10x according to the second example embodiment. As can be understood from the comparison with FIG. 3, the server 10x does not include the in-shelf item detection unit 27, the item image storage unit 28, and the display support information generation unit 29, but other configurations are the same as those in the server 10 according to the first example embodiment.

The item management apparatus 100x operates in the same manner as the item management apparatus 100 according to the first example embodiment, except that displaying of the display support information using the camera for the shelf is not carried out. That is, the item management apparatus 100x displays the replenishment support information in the same manner as that in the first example embodiment, and also corrects the ideal state.

### Third Example Embodiment

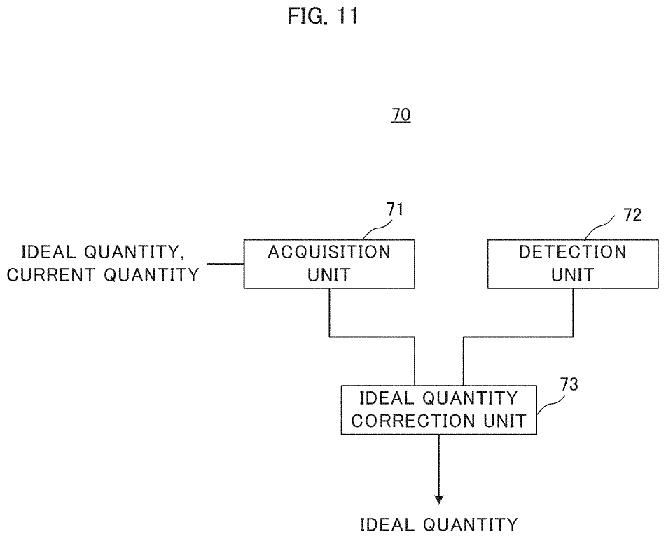

Next, a third example embodiment of the present disclosure will be described. FIG. 11 is a block diagram illustrating a functional configuration of an item management apparatus according to the third example embodiment. An item management apparatus 70 includes an acquisition unit 71, a detection unit 72, and an ideal quantity correction unit 73. The acquisition unit 71 acquires the ideal quantity, which is an ideal quantity of items to be displayed, and the current quantity, which is the number of items actually displayed on the item shelf. The detection unit 72 detects the number of times of the taking-out and placing-back of items with respect to the item shelf. The ideal quantity correction unit 73 corrects the ideal quantity based on the current quantity and the number of times of the taking-out and placing-back.

A part or all of the example embodiments described above may also be described as the following supplementary notes, but not limited thereto.

(Supplementary Note 1)

1. An item management apparatus comprising:
an acquisition unit configured to acquire an ideal quantity indicating an ideal number of items to be displayed, and a current quantity indicating a number of items being actually displayed on an item shelf;
a detection unit configured to detect a number of times of taking out and placing back an item with respect to the item shelf; and an ideal quantity correction unit configured to correct the ideal quantity based on the current quantity and the number of times of taking out and placing back the item.

(Supplementary Note 2)

2. The item management apparatus according to supplementary note 1, wherein the ideal quantity correction unit includes

a sales quantity calculation unit configured to calculate a sales quantity based on a difference between the ideal quantity and the current quantity for each product;

an interest level determination unit configured to determine an interest level for each product; and

a correction process unit configured to correct the ideal quantity based on the sales quantity and the interest level.

(Supplementary Note 3)

3. The item management apparatus according to supplementary note 2, wherein the correction process unit decreases the ideal quantity in a case where the sales quantity is less than a predetermined quantity and the interest level is not high, and retains the ideal quantity in a case where the interest level is high.

(Supplementary Note 4)

4. The item management apparatus according to supplementary note 2 or 3, wherein the correction process unit increases the ideal quantity in a case where the interest level is high.

(Supplementary Note 5)

5. The item management apparatus according to supplementary note 1, wherein the ideal quantity correction unit includes

an interest level determination unit configured to determine an interest level for each product based on the number of times of taking out and placing back the item, and

a correction process unit configured to correct the ideal quantity based on the current quantity and the interest level.

(Supplementary Note 6)

6. The item management apparatus according to supplementary note 5, wherein the correction process unit retains the ideal quantity in a case where the current quantity is less than a predetermined quantity and the interest level is not high, and increases the ideal quantity in a case where the current quantity is less than the predetermined quantity and the interest level is high.

(Supplementary Note 7)

7. The item management apparatus according to supplementary note 5 or 6, wherein the correction process unit increases the ideal quantity regardless of the interest level in a case where the current quantity is zero.

(Supplementary Note 8)

8. The item management apparatus according to any one of supplementary notes 2 through 7, wherein the interest level determination unit determines that the interest level is high when the number of times of taking out and placing back the item is greater than a first predetermined number of times.

(Supplementary Note 9)

9. The item management apparatus according to any one of supplementary notes 2 through 7, wherein

the detection unit detects the number of times of taking out and placing back the item for each person, and

the interest level determination unit determines that the interest level is high in a case where a number of persons for whom the number of times of taking out and placing back the item is greater than a second predetermined number of times.

(Supplementary Note 10)

10. The item management apparatus according to any one of supplementary notes 1 through 9, wherein the detection unit acquires an image that captures the taking out and placing back of the item with respect to the item shelf, and detects the number of times of taking out and placing back the item by analyzing the image.

(Supplementary Note 11)

11. The item management apparatus according to any one of supplementary notes 1 through 10, further comprising a deliverer determination unit configured to acquire a facial image of a person in front of the item shelf and to determine whether or not the person is the deliverer based on the facial image,

wherein the ideal quantity correction unit corrects the ideal quantity in a case where the person in front of the item shelf is a deliverer.

(Supplementary Note 12)

12. The item management apparatus according to supplementary note 11, further comprising:

a replenishment support information generation unit configured to generate replenishment support information including a name of each product that need to be increased or decreased and an increase or decrease quantity based on the current quantity and the corrected ideal quantity in a case where the person in front of the item shelf is the deliverer; and

a display control unit configured to display the replenishment support information on a display device.

(Supplementary Note 13)

13. The item management apparatus according to supplementary note 12, further comprising a display support information generation unit configured to acquire an image of items on the item shelf, and generate display support information including information of each item which is not placed in a correct orientation on the item shelf based on the acquired image, and

wherein the display control unit displays the display support information on the display device.

(Supplementary Note 14)

14. An item management method comprising:

acquiring an ideal quantity indicating an ideal number of items to be displayed, and a current quantity indicating a number of items being actually displayed on an item shelf;

detecting a number of times of taking out and placing back an item with respect to the item shelf; and

correcting the ideal quantity based on the current quantity and the number of times of taking out and placing back the item.

(Supplementary Note 15)

15. A recording medium storing a program, the program causing a computer to perform a process comprising:

acquiring an ideal quantity indicating an ideal number of items to be displayed, and a current quantity indicating a number of items being actually displayed on an item shelf;

detecting a number of times of taking out and placing back an item with respect to the item shelf; and

correcting the ideal quantity based on the current quantity and the number of times of taking out and placing back the item.

While the disclosure has been described with reference to the example embodiments and examples, the disclosure is not limited to the above example embodiments and examples. Various changes that can be understood by those skilled in the art can be made to the structure and details of the present disclosure within the scope of the present invention.

### DESCRIPTION OF SYMBOLS

1 Item shelf
2 Camera for a person
3R, 3L Camera for items
4 Display device
5 Camera for a shelf
10 Server
21 Face detection unit
23 Personal authentication unit
24 Video processing unit
25 Item storage unit
26 Replenishment support information generation unit
29 Display support information generation unit
30 Ideal state correction unit

What is claimed is:

1. An item management apparatus comprising:
a memory storing instructions; and
one or more processors configured to execute the instructions to:
acquire an ideal quantity indicating an ideal number of items to be displayed, and a current quantity indicating a number of items being actually displayed on an item shelf;
detect a number of times of taking out and placing back an item with respect to the item shelf; and
correct the ideal quantity based on the current quantity and the number of times of taking out and placing back the item.

2. The item management apparatus according to claim 1, wherein in order to correct the ideal quantity, the processor is further configured to
calculate a sales quantity based on a difference between the ideal quantity and the current quantity for each product;
an interest level determination unit configured to determine an interest level for each product; and
correct the ideal quantity based on the sales quantity and the interest level.

3. The item management apparatus according to claim 2, wherein the correction processor decreases the ideal quantity in a case where the sales quantity is less than a predetermined quantity and the interest level is not high, and retains the ideal quantity in a case where the interest level is high, to correct the ideal quantity.

4. The item management apparatus according to claim 2, wherein the processor increases the ideal quantity in a case where the interest level is high to correct the ideal quantity.

5. The item management apparatus according to claim 1, wherein in order to correct the ideal quantity, the processor is further configured to
determine an interest level for each product based on the number of times of taking out and placing back the item, and
correct the ideal quantity based on the current quantity and the interest level.

6. The item management apparatus according to claim 5, wherein the processor retains the ideal quantity in a case where the current quantity is less than a predetermined quantity and the interest level is not high, and increases the ideal quantity in a case where the current quantity is less than the predetermined quantity and the interest level is high.

7. The item management apparatus according to, claim 5, wherein the processor increases the ideal quantity regardless of the interest level in a case where the current quantity is zero.

8. The item management apparatus according to claim 2, wherein in a case of determining the interest level for each product, the processor determines that the interest level is high when the number of times of taking out and placing back the item is greater than a first predetermined number of times.

9. The item management apparatus according to claim 2, wherein
the processor detects the number of times of taking out and placing back the item for each person, and
the processor determines that the interest level is high in a case where a number of persons for whom the number of times of taking out and placing back the item is greater than a second predetermined number of times.

10. The item management apparatus according to claim 1, wherein the processor acquires an image that captures the taking out and placing back of the item with respect to the item shelf, and detects the number of times of taking out and placing back the item by analyzing the image.

11. The item management apparatus according to claim 1, wherein the processor is further configured to acquire a facial image of a person in front of the item shelf and to determine whether or not the person is the deliverer based on the facial image, and
wherein the processor corrects the ideal quantity in a case where the person in front of the item shelf is a deliverer.

12. The item management apparatus according to claim 11, wherein the processor is further configured to
generate replenishment support information including a name of each product that need to be increased or decreased and an increase or decrease quantity based on the current quantity and the corrected ideal quantity in a case where the person in front of the item shelf is the deliverer; and
display the replenishment support information on a display device.

13. The item management apparatus according to claim 12, wherein the processor is further configured to acquire an image of items on the item shelf, and generate display support information including information of each item which is not placed in a correct orientation on the item shelf based on the acquired image, and
wherein the processor displays the display support information on the display device.

14. An item management method comprising:
acquiring an ideal quantity indicating an ideal number of items to be displayed, and a current quantity indicating a number of items being actually displayed on an item shelf;
detecting a number of times of taking out and placing back an item with respect to the item shelf; and
correcting the ideal quantity based on the current quantity and the number of times of taking out and placing back the item.

15. A non-transitory computer-readable recording medium storing a program, the program causing a computer to perform a process comprising:
acquiring an ideal quantity indicating an ideal number of items to be displayed, and a current quantity indicating a number of items being actually displayed on an item shelf;
detecting a number of times of taking out and placing back an item with respect to the item shelf; and
correcting the ideal quantity based on the current quantity and the number of times of taking out and placing back the item.
